(19) United States
(12) Patent Application Publication
(10) Pub. No.: US 2026/0158300 A1
(43) Pub. Date: Jun. 11, 2026

(54) MODULAR SELF CONTAINED BREATHING APPARATUS AND POWERED AIR PURIFYING RESPIRATOR SYSTEM

(71) Applicant: D. Wheatley Enterprises, Inc., Belcamp, MD (US)

(72) Inventors: Joseph Craig Martin, Belcamp, MD (US); Randy Scott Reed, Belcamp, MD (US); William Michael Lydick, Belcamp, MD (US)

(21) Appl. No.: 19/414,600

(22) Filed: Dec. 10, 2025

Related U.S. Application Data
(60) Provisional application No. 63/730,222, filed on Dec. 10, 2024.

(51) Int. Cl. A62B 7/10; A62B 7/02; A62B 9/00; A62B 9/02; A62B 9/04

(52) U.S. Cl. CPC A62B 7/10; A62B 7/02; A62B 9/006; A62B 9/02; A62B 9/022; A62B 9/04

(57) ABSTRACT

A modular breathing apparatus system integrating self-contained breathing apparatus (SCBA) and powered air purifying respirator (PAPR) capabilities in a unified platform includes a body-worn carrier frame with a removable air canister carrier configured to accommodate varying configurations of pressurized air canisters. A PAPR system with filter cartridges and blower removably attaches to the air canister carrier via a latching mechanism. A second stage regulator configured for connection to protective equipment selectively receives air from either the PAPR system or the SCBA system through an integrated shutoff mechanism. The modular design enables rapid reconfiguration between different air canister configurations without modifying other system components. The air canister carrier can be swapped to accommodate different sizes and numbers of pressurized air canisters while maintaining compatibility with the integrated PAPR system, addressing inefficiencies in traditional separate SCBA and PAPR systems and providing operational flexibility for varied mission requirements.

### CROSS-REFERENCE TO RELATED APPLICATIONS

This application claims priority to U.S. Provisional Patent Application No. 63/730,222, filed Dec. 10, 2024 and titled “Modular Self Contained Breathing Apparatus and Powered Air Purifying Respirator System,” the specification of which is incorporated herein by reference in its entirety.

### FIELD OF THE INVENTION

The present invention relates generally to breathing apparatus systems and, more particularly, to a modular combined self-contained breathing apparatus (SCBA) and powered air purifying respirator (PAPR) system that is body-worn by a user and readily reconfigurable to meet varied mission demands.

### BACKGROUND OF THE INVENTION

Self-contained breathing apparatus (SCBA) systems are closed-circuit respiratory protection devices that provide breathable air from a self-contained compressed air source, typically carried in one or more high-pressure cylinders mounted on the user's back. SCBA systems are essential personal protective equipment in immediately dangerous to life or health (IDLH) environments such as structural firefighting, hazardous material response, confined space entry, and industrial emergency response where ambient air may be contaminated with toxic substances, deficient in oxygen, or of unknown composition. A typical SCBA system includes high-pressure compressed air cylinders (operating at pressures typically ranging from 2216 psi to 4500 psi or higher), a pressure reduction and regulation system that steps down the high pressure to breathable levels, a demand valve that delivers air in response to user inhalation, delivery hoses connecting the air supply to the user's facepiece, and a tight-fitting face mask or full facepiece that creates a sealed breathing environment. The operational duration of an SCBA system depends primarily on the total capacity of the compressed air cylinders and the user's air consumption rate, which varies based on physical exertion level and individual physiology. Standard SCBA configurations typically provide between 30 and 60 minutes of operational time under working conditions, though extended-duration configurations with larger or multiple cylinders may provide longer service times.

A significant limitation of conventional SCBA systems is their fixed cylinder configuration design. Most traditional SCBA systems are manufactured with an integrated backplate and harness assembly designed to accommodate a specific cylinder configuration either a single cylinder of a particular size, or a specific arrangement of multiple cylinders. When mission requirements change and different air supply durations are needed, users cannot simply swap cylinder configurations on their existing SCBA platform. Instead, they must either purchase and maintain completely separate SCBA systems for each desired cylinder arrangement, or compromise by using a single configuration that may provide excessive capacity (and weight) for some missions while providing insufficient duration for others. This inflexibility creates substantial inefficiencies in equipment procurement, as organizations must invest in multiple complete SCBA systems to address varying operational scenarios. It also increases storage and transportation requirements, as each complete system must be maintained, inspected, and transported separately. Training complexity increases as well, since users must become familiar with multiple distinct systems, each potentially having slightly different operational characteristics and maintenance requirements. The inability to readily adapt cylinder capacity to specific mission parameters represents a longstanding limitation in SCBA system design that impacts operational efficiency, equipment costs, and logistical planning.

Powered air purifying respirator (PAPR) systems represent a fundamentally different approach to respiratory protection. Rather than supplying air from a self-contained source, PAPR systems draw ambient air through filtration media using a battery-powered blower unit, then deliver the filtered air to the user's breathing zone through a breathing hose. The blower creates positive pressure in the user's facepiece or hood, ensuring that any leakage flows outward rather than allowing contaminated ambient air to enter. PAPR systems are appropriate for use in contaminated environments where the contaminant type and concentration are known, the oxygen concentration is adequate to support life (typically at least 19.5% oxygen), and contaminant levels are below IDLH thresholds. By selecting appropriate filter cartridges, such as particulate filters, chemical/vapor filters, or combination filters, PAPR systems can provide effective protection against a wide range of airborne hazards including dusts, mists, fumes, gases, and vapors.

PAPR systems offer several operational advantages over SCBA systems in appropriate (non-IDLH) environments. First, PAPR systems typically provide significantly longer operational duration, often ranging from four to eight hours or more depending on battery capacity and blower power requirements, compared to the 30-60 minute typical duration of SCBA systems. This extended duration makes PAPR systems particularly valuable for operations requiring sustained respiratory protection over long periods, such as extended decontamination operations, prolonged remediation work, or industrial processes involving continuous exposure to known contaminants. Second, because the blower provides positive pressure and continuous airflow, PAPR systems typically impose less breathing resistance than SCBA demand valve systems, reducing user fatigue during extended wear. Third, PAPR systems are generally lighter than SCBA systems since they do not require heavy high-pressure air cylinders, reducing the physical burden on users during extended operations. Fourth, PAPR systems eliminate concerns about air supply depletion, as they can continue operating as long as battery power remains and filters maintain adequate capacity for the contaminant loading encountered.

Despite these complementary advantages, traditional PAPR and SCBA systems have been developed as completely separate, incompatible technologies. Organizations and individuals requiring both SCBA capabilities (for IDLH environments or unknown conditions) and PAPR capabilities (for extended operations in characterized, non-IDLH environments) must purchase, maintain, train on, store, and transport two entirely distinct respiratory protection systems. Each system has its own unique backpack or carrying apparatus, its own harness and strap system, its own breathing hose configurations, and its own facepiece connection methods. This complete separation of technologies creates multiple operational inefficiencies and imposes significant practical burdens on users and organizations.

The separation of SCBA and PAPR technologies into distinct, incompatible systems creates substantial operational challenges, particularly in dynamic environments where contamination levels or operational requirements may change during a mission. First responders frequently encounter such dynamic conditions. For example, firefighters conducting overhaul operations after fire suppression initially require SCBA protection during active fire involvement and immediately afterward when toxic combustion products remain at high concentrations. However, as ventilation clears the structure and hot spots are extinguished, conditions may transition to lower-level contamination more appropriate for PAPR protection. Continuing to use SCBA throughout extended overhaul work consumes air supplies rapidly and requires frequent cylinder changes or may force premature mission termination when air supplies are exhausted. Conversely, switching to PAPR for extended overhaul work could significantly extend operational duration and reduce user fatigue, but this requires carrying a complete separate PAPR system in addition to the SCBA, substantially increasing the weight and bulk burden on the firefighter.

Similarly, hazardous materials response teams routinely face evolving conditions during emergency response operations. Initial entry into an uncharacterized hazardous environment requires SCBA protection due to unknown contaminants and concentrations. However, once the hazardous material is identified through monitoring and assessment, and if conditions are determined to be non-IDLH with adequate oxygen levels, transitioning to PAPR with appropriate filters would allow significantly extended operational duration for decontamination, remediation, and cleanup operations. With current separate systems, responders must either carry both a complete SCBA system and a complete PAPR system (creating excessive weight and bulk), or commit to using SCBA for the entire operation (limiting operational duration and requiring frequent air supply changes), or exit the contaminated area, completely change respiratory protection systems, and re-enter (consuming valuable time and potentially losing operational continuity).

Industrial applications present similar challenges. Workers conducting maintenance or inspection in confined spaces may initially require SCBA due to unknown atmospheric conditions or while performing work that disturbs potentially hazardous materials. Once atmospheric monitoring confirms acceptable oxygen levels and characterizes contaminant types and concentrations as non-IDLH, transitioning to PAPR would allow extended work duration without the constraints of limited air supply. Manufacturing and processing operations involving multiple work zones with varying contamination levels may require workers to transition between areas needing SCBA protection and areas where PAPR protection is appropriate. Emergency response planning is complicated when organizations must procure, maintain, and train personnel on two completely separate respiratory protection systems to address this range of scenarios.

The complete separation of SCBA and PAPR systems also creates equipment cost implications. Organizations must invest in two complete systems per user if both capabilities are required, doubling procurement costs, maintenance costs, inspection costs, and spare parts inventory requirements. Storage and transportation requirements are likewise doubled, which is particularly problematic for mobile response units with limited vehicle space. Training requirements increase substantially, as users must become proficient in the operation, maintenance, and emergency procedures for two distinct systems. Logistical planning becomes more complex, as incident commanders must determine in advance which system type to deploy, or must ensure that both complete systems are transported to incident scenes where conditions may be uncertain or may change.

Furthermore, even within SCBA systems alone, the inability to readily modify compressed air cylinder configurations without replacing entire systems creates significant operational and financial constraints. Different operational scenarios demand different air supply durations. A confined space rescue operation or interior structural firefighting may require maximum air capacity to provide the longest possible operational time before the rescuer must exit for air supply replenishment. Conversely, routine industrial facility monitoring, brief inspections in potentially contaminated areas, or rapid intervention team standby operations may benefit from reduced cylinder capacity, which decreases system weight and bulk, reduces user fatigue, and improves mobility and agility. External firefighting operations, vehicle fires, or other scenarios with shorter expected air demand may similarly benefit from lighter, more compact cylinder arrangements.

With conventional SCBA systems, adapting to these varying requirements typically necessitates purchasing completely separate SCBA systems optimized for each cylinder configuration. A fire department or industrial facility might need to maintain SCBA systems with single 30-minute cylinders for some applications, systems with single 60-minute cylinders for standard operations, and systems with dual cylinders for maximum-duration operations. Each complete system includes not only the cylinders but also the backplate, harness, regulator systems, gauges, hoses, and all associated components, all of which are essentially identical across the different configurations except for the cylinder mounting arrangement. This multiplication of complete systems to achieve cylinder configuration flexibility represents substantial duplicative costs and inefficient use of resources. Maintenance and inspection requirements multiply accordingly, as each complete system must be individually serviced and certified. Spare parts inventory becomes more complex when maintaining multiple distinct SCBA platforms. Training may also be complicated if different cylinder configurations result in different weight distributions, different donning procedures, or different user handling characteristics.

The lack of integration between SCBA and PAPR technologies, combined with the inflexibility of SCBA cylinder configurations, represents a significant gap in respiratory protection system design that has persisted despite the clear operational need for greater flexibility and adaptability. Users and organizations requiring diverse respiratory protection capabilities across varying environmental conditions and mission durations face difficult choices: accept the weight, bulk, and cost burden of carrying and maintaining multiple complete systems; compromise by selecting a single system that is suboptimal for some applications; or limit their operational capabilities by not having appropriate respiratory protection for all scenarios they may encounter.

There remains a significant and longstanding need in the art for an integrated respiratory protection system that combines both SCBA and PAPR capabilities in a single unified, body-worn platform, allowing users to access either breathing mode without carrying duplicate equipment systems. Such an integrated system should enable users to seamlessly switch between compressed air supply (SCBA mode) and filtered ambient air supply (PAPR mode) based on real-time environmental conditions and operational requirements. The system should further provide modularity in SCBA cylinder configurations, allowing rapid reconfiguration to accommodate different numbers and sizes of compressed air cylinders to match mission-specific duration requirements, while maintaining full compatibility with integrated PAPR components such that the same PAPR unit can be used regardless of which SCBA cylinder configuration is installed. An effective solution would reduce overall system weight and bulk compared to carrying separate independent SCBA and PAPR systems, minimize equipment procurement and maintenance costs through shared components and platform commonality, simplify training and operational procedures by integrating both capabilities into a unified system architecture, and provide the flexibility to quickly adapt to varying operational requirements and changing environmental conditions. The system should maintain full functionality, safety standards, and regulatory compliance for both SCBA and PAPR operations while providing ease of reconfiguration sufficient to enable field changes between different system configurations without requiring specialized tools or lengthy disassembly procedures. Such a modular, integrated respiratory protection system would address multiple longstanding limitations in current respiratory protection technology and provide substantial operational, logistical, and economic benefits to users requiring flexible, adaptable respiratory protection capabilities.

### SUMMARY OF THE INVENTION

The limitations of conventional respiratory protection systems, including the complete separation of SCBA and PAPR technologies into incompatible platforms and the inflexibility of fixed SCBA cylinder configurations, create substantial operational challenges for users requiring adaptable respiratory protection across varying environmental conditions and mission requirements. The present invention addresses these longstanding needs through a modular respiratory protection system that integrates both self-contained breathing apparatus (SCBA) and powered air purifying respirator (PAPR) capabilities into a single unified, body-worn platform while providing the flexibility to rapidly reconfigure SCBA compressed air cylinder arrangements without modifying other system components.

In accordance with certain aspects of an embodiment, disclosed herein is a modular system that integrates both self-contained breathing apparatus (SCBA) and powered air purifying respirator (PAPR) capabilities into a single unified platform carried on a common body-worn carrier frame. The system architecture is built around a removable air canister carrier that is configured for quick attachment to and detachment from the carrier frame. The air canister carrier is specifically designed to accommodate one or more pressurized air canisters in various configurations, including different numbers of canisters and different canister sizes, to meet specific mission duration requirements. Each differently configured air canister carrier (such as a carrier configured for dual small canisters, a carrier configured for dual large canisters, or a carrier configured for a single canister) is designed to interface with the same PAPR system and the same carrier frame, enabling the user to select and install the air canister carrier configuration most appropriate for a particular mission without requiring different PAPR equipment or different carrier frames.

The PAPR system itself is configured as a removable unit that can be quickly detached from one air canister carrier configuration and reattached to a different air canister carrier configuration. The PAPR system includes filter cartridges for removing contaminants from ambient air, a battery-powered blower unit that draws air through the filter cartridges and delivers filtered air under positive pressure, and an air delivery hose that conveys the filtered air toward the user. A latching mechanism integrated into the PAPR system enables secure attachment to the air canister carrier while permitting rapid manual release for removal. In certain embodiments, the latching mechanism may include a manually operated handle or lever that, when actuated, disengages latches positioned on an interior surface of the PAPR system housing, allowing the PAPR unit to be lifted away from the air canister carrier. This quick-release latching design is a key enabler of the system's modularity, as it allows the same PAPR unit to be transferred between different air canister carrier configurations without tools or complex disassembly procedures. When an operator determines that a different SCBA cylinder configuration is needed, such as switching from dual small cylinders to dual large cylinders for an extended-duration mission, the operator can quickly unlatch and remove the PAPR system, remove the current air canister carrier from the carrier frame, install the alternative air canister carrier configuration onto the carrier frame, and re-latch the PAPR system onto the newly installed air canister carrier, all in a matter of minutes without specialized equipment.

The system is particularly configured to enable seamless switching between SCBA mode (breathing supplied air from the pressurized canisters) and PAPR mode (breathing filtered ambient air) through an integrated second stage regulator. The second stage regulator is configured for direct connection to a user's protective equipment, such as a protective mask or full facepiece, and includes an outlet through which breathing air is delivered to the user. The second stage regulator receives two distinct air supply inputs: filtered air from the PAPR system via the air delivery hose, and compressed air from the SCBA system via an SCBA air hose that connects to an outlet from the manifold affixed to the air canister. A filter shutoff mechanism integrated into the second stage regulator enables selective control of which air source supplies the user. In certain embodiments, the filter shutoff mechanism includes a movable sealing valve that can be positioned to either permit airflow from the PAPR system while blocking the SCBA air pathway, or to block airflow from the PAPR system while permitting airflow from the SCBA air supply. The user can actuate this switching through a manually operated switch or control, enabling rapid transition between breathing modes based on changing environmental conditions or operational requirements. For example, during initial entry into an uncharacterized or potentially IDLH environment, the user can operate the system in SCBA mode to breathe supplied air from the pressurized canisters. Once environmental monitoring confirms that conditions are non-IDLH with adequate oxygen levels and identified contaminants that can be effectively filtered, the user can switch the second stage regulator to PAPR mode, conserving the pressurized air supply while extending operational duration through the PAPR system's longer-lasting battery and filter capacity. This integrated switching capability, provided within a single unified system, eliminates the need to carry separate SCBA and PAPR equipment or to exit the work area to change respiratory protection systems.

The system further incorporates several features that enhance operational capability and user safety. The SCBA portion of the system may include a recharge connector in fluid communication with the manifold, allowing the pressurized air canisters to be refilled from an external compressed air source without removing the canisters from the system. This recharge capability extends operational duration by enabling in-field replenishment of air supplies. The recharge connector may include one or more refill ports configured with quick-connect fittings for rapid connection to an air supply line, along with an integrated pressure gauge that provides visual indication of the air pressure being supplied from the SCBA system. The system may also include an integrated low pressure audible alarm system configured to emit an audible warning tone when pressure in the SCBA air supply falls below a predetermined threshold, such as when air remaining drops below 25% of capacity. In certain embodiments, this low pressure alarm system comprises a whistle actuator mechanism positioned at or near the manifold that senses system pressure, and a remote flute assembly positioned adjacent the user's head (such as near the shoulder area) that emits the audible warning tone. The remote flute assembly may include a manually operated silence sleeve that enables the user to stop the alarm tone in situations where silence is operationally required, while maintaining a check valve function to prevent backflow of ambient air into the SCBA system.

The PAPR system may be configured with an easily accessible battery replacement mechanism that permits removal and replacement of the power supply battery without requiring removal of the PAPR unit from the air canister carrier. In certain embodiments, this battery replacement mechanism includes a release button or actuator positioned on an exterior surface of the PAPR housing along with a slider or latch that releases the battery from internal electrical connections, allowing the user to extract a depleted battery and insert a fresh battery while the system remains mounted on the carrier frame. This design minimizes system downtime during extended operations requiring battery changes. The second stage regulator may be configured with a swivel attachment mechanism that allows rotational freedom between the regulator and the user's protective mask, preventing hose binding and maintaining connection integrity during head movements and operational activities. The combination of these features, including integrated SCBA/PAPR operation, modular cylinder configuration, recharge capability, pressure monitoring and alarms, field-replaceable battery, and swivel connections, creates a comprehensive respiratory protection system with significantly enhanced operational flexibility compared to conventional separate systems.

The modular approach disclosed herein provides substantial operational advantages over conventional respiratory protection systems. By integrating SCBA and PAPR capabilities into a single platform with a common carrier frame and shared components, the invention reduces the total weight and bulk that must be carried compared to carrying two separate, complete respiratory protection systems. This weight reduction decreases user fatigue during extended operations and improves mobility and agility in confined or complex environments. The integration also provides significant cost savings through component sharing; i.e., a single carrier frame, single second stage regulator, single set of breathing hoses, and single facepiece connection serve both SCBA and PAPR functions, eliminating the need to purchase duplicate components. Equipment maintenance, inspection, and spare parts inventory requirements are likewise reduced through this component commonality. The modular SCBA cylinder configuration capability provides additional cost benefits by enabling a single carrier frame and PAPR system to be used with multiple different air canister carrier configurations, rather than requiring completely separate SCBA systems for different duration requirements. Training is simplified because users learn to operate a single unified system rather than two distinct platforms, and the switching mechanism between SCBA and PAPR modes can be integrated into a single set of operational procedures. Logistically, the system provides greater flexibility in responding to uncertain or changing environmental conditions, as users have immediate access to both supplied-air and filtered-air capabilities without carrying redundant equipment or requiring prior commitment to a single protection mode. Mission duration can be optimized by selecting the appropriate SCBA cylinder configuration before deployment and by switching to PAPR mode when environmental conditions permit, maximizing operational time while maintaining appropriate protection levels.

The invention further contemplates various alternative embodiments and configurations while maintaining the core inventive concept of modular integration. Air canister carriers may be configured for a single pressurized air canister, for two canisters arranged side-by-side, or for other multi-canister arrangements. Canisters may be provided in various capacity ratings and physical sizes, with corresponding air canister carriers designed to accommodate each size while maintaining compatibility with a common PAPR system and carrier frame. The second stage regulator may be provided in alternative configurations, including standard and compact versions, both providing the integrated filter shutoff mechanism that enables selective switching between PAPR and SCBA air sources. The filter cartridges for the PAPR system may be selected from various types appropriate for different contaminant profiles, including particulate filters, chemical/vapor filters, or combination filters, allowing the system to be configured for specific hazard environments. The manifold system affixed to the air canister may include various valving and pressure control arrangements, and may incorporate connections for pressure gauges, low pressure alarm systems, and recharge connectors in various configurations. These and other variations fall within the scope of the inventive concept disclosed herein.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The numerous advantages of the present invention may be better understood by those skilled in the art by reference to the accompanying drawings in which:

FIG. 1 is a back view of a modular SCBA/PAPR system in accordance with certain aspects of an embodiment of the invention and configured for two canisters of pressurized air.

FIG. 1(a) is a detail exploded view of the cylinder assembly of the SCBA portion of the modular SCBA/PAPR system of FIG. 1.

FIG. 2 is a side perspective view of the modular SCBA/PAPR system of FIG. 1.

FIG. 3 is a side view of the modular SCBA/PAPR system of FIG. 1.

FIG. 4 is a front view of the modular SCBA/PAPR system of FIG. 1.

FIG. 5 is a close-up perspective view of a recharge connector and low pressure audible alarm for use in the modular SCBA/PAPR system of FIG. 1.

FIG. 5(a) is an exploded view of the recharge connector of FIG. 5.

FIG. 5(b) is an exploded view of the low pressure audible alarm of FIG. 5.

FIG. 5(c) is a detail view of the whistle activator connecting to the bottle manifold for use in the modular SCBA/PAPR system of FIG. 1.

FIG. 5(d) is a cross-sectional view of the whistle actuator of FIG. 5(c).

FIG. 5(e) is an exploded view of the whistle actuator of FIG. 5(c).

FIG. 6 is a back view of the modular SCBA/PAPR system of FIG. 1 configured for two larger-sized canisters of pressurized air.

FIG. 7 is a back view of the modular SCBA/PAPR system of FIG. 1 configured for a single canister of pressurized air.

FIG. 8 is a back view showing a comparison of the alternatively configured SCBA/PAPR systems of FIGS. 1, 6, and 7.

FIG. 9 is a top view showing a comparison of the alternatively configured SCBA/PAPR systems of FIGS. 1, 6, and 7.

FIG. 10 is a side view showing a comparison of the alternatively configured SCBA/PAPR systems of FIGS. 1, 6, and 7.

FIGS. 11-13 provide schematic views showing the steps for removal of the PAPR system from the modular SCBA/PAPR system of FIG. 1.

FIGS. 14-17 provide schematic views showing the steps for changing a battery for powering the PAPR portion of the modular SCBA/PAPR system of FIG. 1.

FIG. 18 is a side cross-sectional view of the second stage regulator of the modular SCBA/PAPR system of FIG. 1 with airflow being provided from the PAPR portion of the system to the outlet.

FIG. 19 is a side cross-sectional view of the second stage regulator of the modular SCBA/PAPR system of FIG. 1 with airflow being provided from the SCBA portion of the system to the outlet.

FIG. 19(a) is a side cross-sectional view of the second stage regulator of the modular SCBA/PAPR system of FIG. 1 in a compact configuration with airflow being provided from the PAPR portion of the system to the outlet.

FIG. 19(b) is a side cross-sectional view of the second stage regulator of the modular SCBA/PAPR system of FIG. 1 in a compact configuration with airflow being provided from the SCBA portion of the system to the outlet.

FIG. 20 is an exploded view of the shutoff sleeve portion of the second stage regulator assembly of FIGS. 18-19(b).

FIG. 21 is an exploded view of the combination hose assembly that extends from the PAPR portion blower to the demand valve and mask swivel housing of the modular SCBA/PAPR system of FIG. 1.

### DETAILED DESCRIPTION OF THE PREFERRED EMBODIMENTS

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

Disclosed in accordance with certain aspects of an embodiment of the invention and with reference to the enclosed drawings is a modular system 100 incorporating both a self contained breathing apparatus (“SCBA”) system and a powered air purifying respirator (“PAPR”) system that provides an integrated assembly that may be easily and quickly modified to carry air cylinders for the SCBA system that may vary in size and number to meet the requirements of a particular application without requiring the modification of other components of the modular system. The modular SCBA/PAPR system includes a second stage regulator configured for direct connection to a user's protective equipment, such as a protective mask, which second stage regulator selectively receives air from either the SCBA system or the PAPR system through a PAPR system filter shutoff integrated into the second stage regulator.

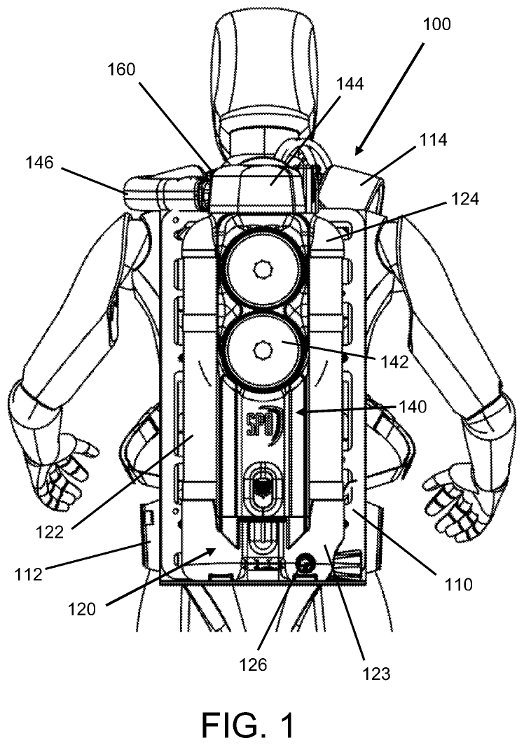

With particular reference to FIG. 1, modular SCBA/PAPR system 100 includes a body-worn carrier frame 110 having a waist strap 112 and shoulder straps 114 enabling an operator to carry the modular SCBA/PAPR system 100 on their back. An SCBA air canister carrier 120 is removably attached to the back side of carrier frame 110, such as through the use of threaded connectors or such other connectors as will allow quick removal of air canister carrier 120 from carrier frame 110 when desired. Air canister carrier 120 is configured to receive one or more canisters 122 of pressurized air for delivering clean air from a contained source to the user in an SCBA operating mode, as discussed in greater detail below. Air canister carrier 120 is also configured to removably receive and carry PAPR system 140 for delivering filtered air to the user in a PAPR operating mode, likewise as discussed in greater detail below.

Air canister carrier 120 includes a bottom canister receiver 123 and a top canister receiver 124. As shown in the figures, bottom canister receivers may be configured to receive, in the exemplary configurations depicted in the figures, one canister 122 of pressurized air or two canisters 122 of pressurized air, and such canisters 122 may be provided in differing sizes with a dedicated, removable bottom and top canister receiver 123/124 provided for each such canister configuration, thus enabling a customized SCBA assembly that is configured for a particular use scenario. Each bottom canister receiver 123 provides access to a manual compressed air control 125, such as a wheel that may be manually turned, and that engages a manifold 133 affixed to the outlet of one of the air canisters 122 to control flow of pressurized air from the one or more canisters into a first stage regulator and onward to the user. Such first stage regulator is of standard configuration to those used in SCBA equipment and thus is not further detailed here. Additionally, a pressure gauge 126 may be provided that engages the manifold to enable reading of the pressure of air that is being supplied from canisters 122 (via the manifold) to the user. FIG. 1(a) provides a detailed exploded view of the structural arrangement of the SCBA cylinder assembly components. As shown in FIG. 1(a), the cylinder assembly may include a primary cylinder 122(a) and a remote cylinder 122(b), which are interconnected through fitting components including fittings 172 adapted for stainless steel tubing connections. The cylinder assembly further includes a hard line umbilical 173 and O-ring seals 174 to ensure pressure-tight connections between the various cylinder assembly components. This modular cylinder assembly configuration allows for the pressurized air from canisters 122 to be efficiently delivered to the manifold 133 for distribution to the user.

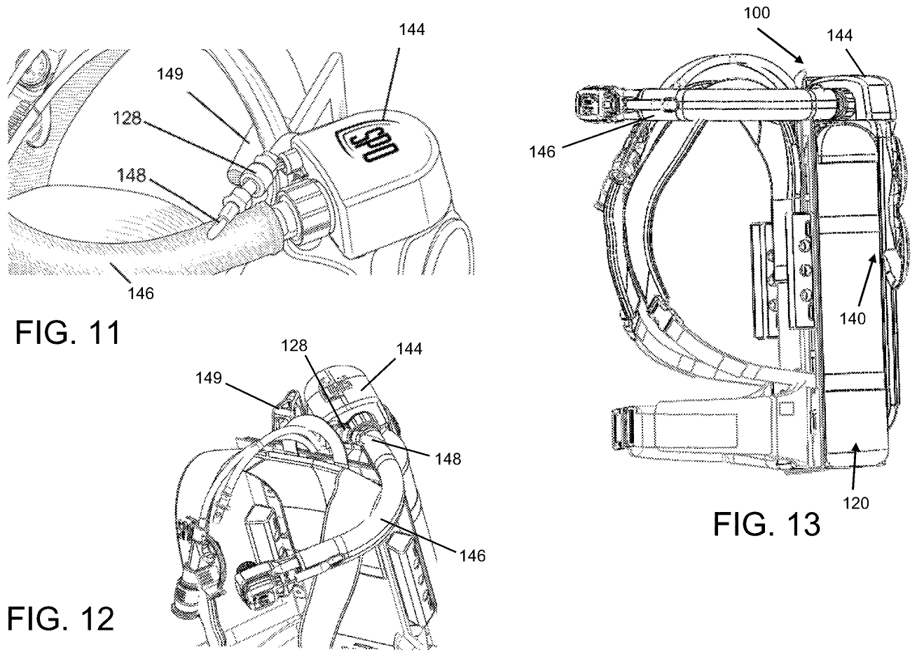

PAPR system 140 is removably attached to air canister carrier 120, and includes filter cartridges 142, a blower 144 which, when operated, draws air through filter cartridges 142, and an air delivery hose 146 for delivering filtered air from the blower 144 to a second stage regulator 160 that, in turn, is configured for removable attachment to a user's protective equipment, such as a protective mask. An SCBA air hose 148 (FIGS. 11 and 12) is preferably attached to or integrated with air delivery hose 146 and delivers air to second stage regulator 160 from an SCBA air outlet 128 from the SCBA system to which the SCBA air hose 148 may be removably attached. As discussed in more detail below, PAPR system 140 may include one or more mechanical latches that allow an interior side of PAPR system 140 to latch onto air canister carrier 120, and which when manually operated may disengage from such latches to allow removal of PAPR system 140 from the air canister carrier 120, such as when it is desirable to change the configuration of the SCBA system to differently sized or differing number of canisters 122 of pressurized air. In this manner, when an operator wishes to change the SCBA system, PAPR system 140 may be quickly removed, the air canister carrier 120 (and its associated canister(s) 122) may be removed from carrier frame 110, the alternately configured air canister carrier 120 (and its associated canister(s) 122) may be mounted onto carrier frame 110, and PAPR system 140 may be quickly latched back onto the alternately configured air canister carrier 120. In an exemplary configuration, the mechanical latches may comprise one or more hooks on an underside of PAPR system 140 that engage with a spring-biased latch member extending outward from air canister carrier 120, which spring-biased latch member may retract into air canister carrier 120 when manually operated to allow disconnection and removal of PAPR system 140 from air canister carrier 120. Of course, such mechanical latching mechanism is exemplary and those of ordinary skill in the art may readily modify the configuration without departing from the scope of the invention.

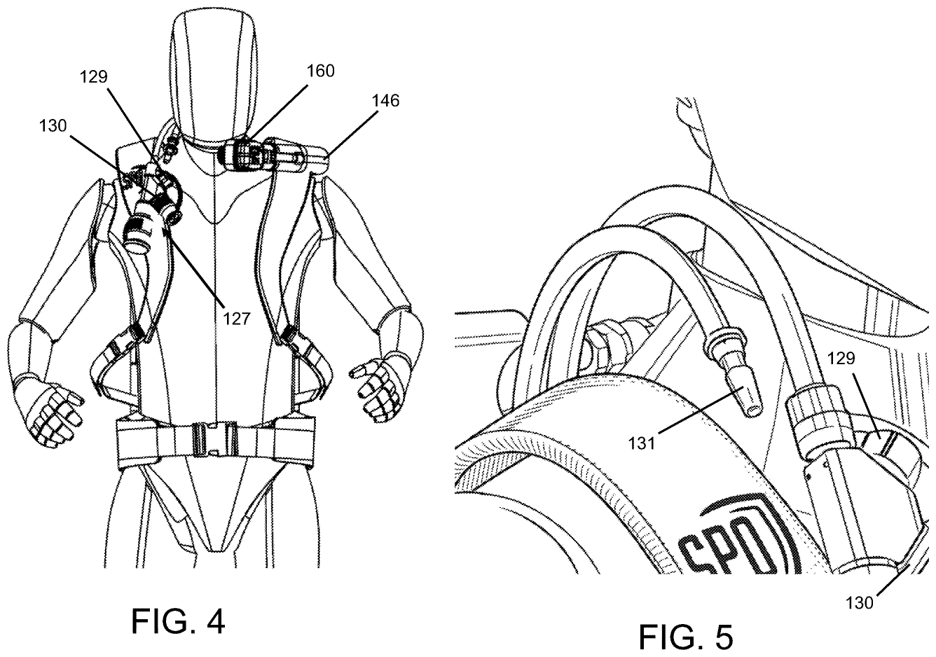

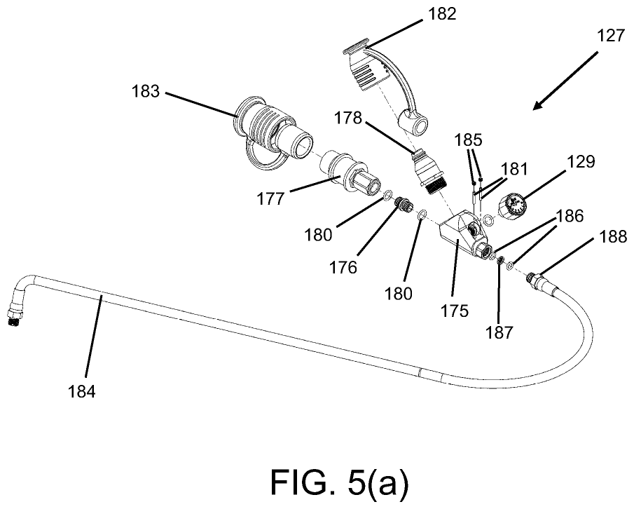

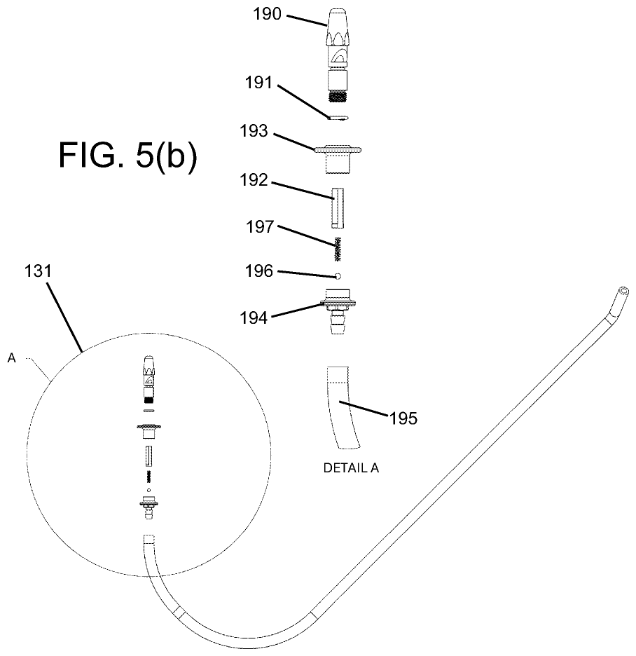

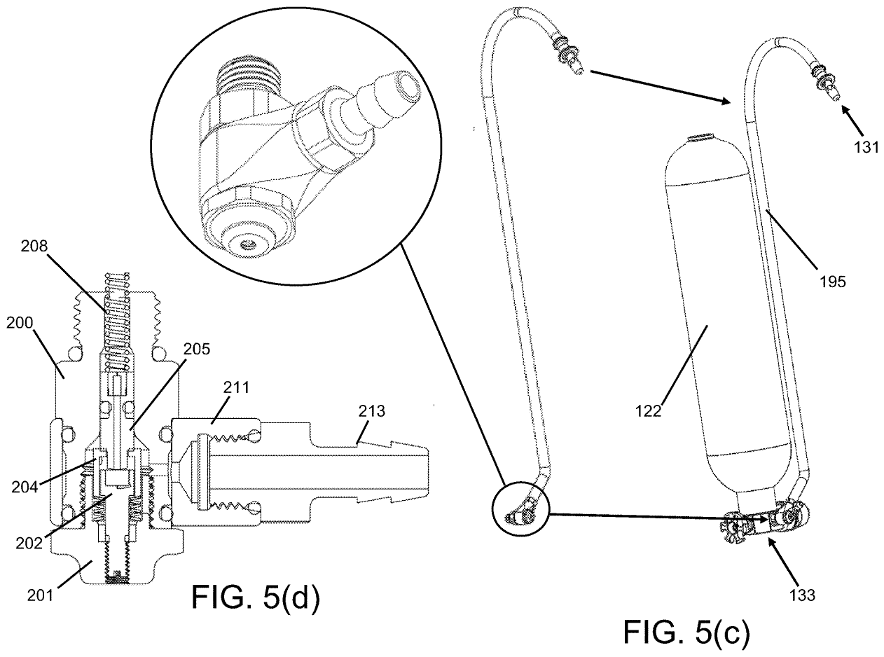

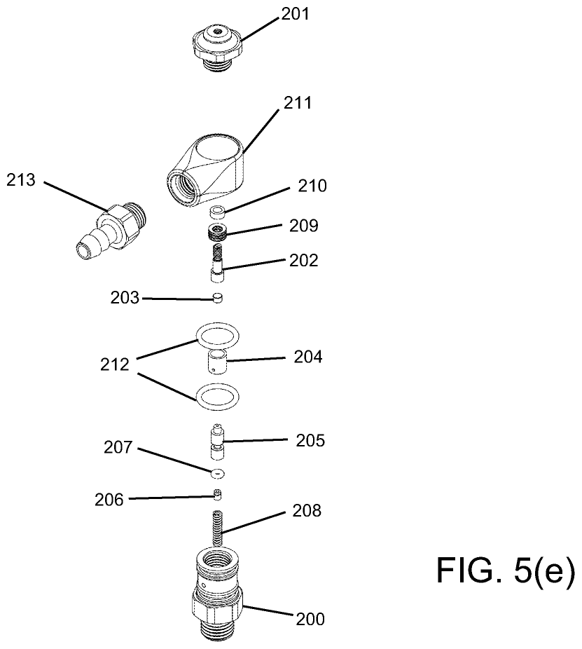

As best shown in FIGS. 4 and 5, the SCBA system may include a recharge connector 127 that is attached to a hose extending from the manifold 133 over the user's shoulder. Recharge connector 127 may include a pressure gauge 129 that is viewable within the user's field of view when wearing a protective mask to provide a visual reading of the air pressure supplied by the SCBA system, along with refill ports 130 enabling an external source of compressed air to be connected to the SCBA system for refilling of canisters 122. FIG. 5(a) provides a detailed exploded view showing the internal components and construction of recharge connector 127. As illustrated in FIG. 5(a), recharge connector 127 comprises a recharge body assembly 175 that forms the main housing structure of the connector. The recharge body assembly 175 receives a male-to-male SAE-04 adapter 176 that provides the primary air connection interface. An FD17 female connector 177 threads into the adapter 176 and cooperates with an FD17 male quick disconnect 178 to provide rapid connection and disconnection capability for the refill operation. Pressure gauge 129 having a No. 4 SAE fitting is mounted to the recharge body assembly 175 to provide the visual pressure indication to the user. Multiple O-ring seals 180 are positioned at key junctions to maintain pressure integrity throughout the connector assembly. A pair of retaining pins 181 secure various components in their operational positions. Dust covers 182, 183 (one male and one female) protect the quick disconnect fittings when not in use. The hose assembly 184 extends from the recharge body to connect to manifold 133, and a pair of set screws 185 secure critical components against loosening during operation. Additional O-ring seals 186 and a split backup ring 187 provide redundant sealing at high-pressure interfaces. A swivel fitting 188 for the high-pressure hose allows rotational freedom to prevent hose twisting during connection operations.

Further, a low pressure audible alarm 131 may be provided comprising a whistling valve positioned adjacent the user's head (the opposite end of the whistling valve connecting hose being connected to the manifold 133) and configured to emit a whistling tone when a pressure in the SCBA system falls below a designated alarm level (e.g., below 25% capacity). Such whistling valve may preferably have a snap closure enabling the operator to snap the valve closed to stop the whistling valve from emitting the tone, such as in situations where quiet or silence may be warranted. Such whistling valve also preferably comprises a check valve that ensures that ambient air cannot backfill into the SCBA system. FIG. 5(b) provides a detailed exploded view of the remote flute assembly portion of low pressure audible alarm 131, showing the components that produce the audible warning tone near the user's head. As shown in FIG. 5(b), the remote flute assembly includes a remote flute 190 that forms the primary housing for the whistle mechanism. An O-ring seal 191 provides sealing at a key interface within the assembly. A flute insert 192 is positioned within the remote flute 190 and cooperates with the other components to generate the whistling sound. A silence sleeve 193 is movably positioned relative to the flute insert 192 and can be manually actuated to close off the airflow path and silence the alarm, providing the snap closure functionality referenced above. The assembly further includes a flute barb check valve 194 that serves the dual purpose of providing a hose connection interface and incorporating check valve functionality to prevent backflow of ambient air into the SCBA system. A whistle hose 195 extends from the flute barb check valve 194 to connect the remote flute assembly to the whistle actuator at the manifold 133, thereby enabling pressure signals from the manifold to activate the audible warning at the remote flute location. A rubber ball 196 and spring 197 function as part of the check valve mechanism within the flute barb check valve 194, ensuring unidirectional airflow through the alarm system.

As illustrated in FIGS. 5(c), 5(d), and 5(e), the whistle actuator mechanism that connects to the manifold 133 is configured to sense system pressure and trigger the low-pressure warning when pressure drops below the predetermined threshold. FIG. 5(c) provides a schematic view showing the whistle activator connecting the hose 195 of low pressure alarm 131 to the bottle manifold. FIG. 5(d) provides a cross-sectional view of the whistle actuator showing the internal arrangement of components, and FIG. 5(e) provides a detailed exploded view of the whistle actuator assembly, showing the individual components and their assembly sequence. The whistle actuator includes a small body 200 configured in a banjo-style connection that serves as the main housing for the actuator mechanism and provides the connection interface to the manifold 133. A cap 201 for the whistle adjusting mechanism in the banjo configuration secures the upper portion of the assembly and provides access to the adjustment components. An adjusting screw 202 engages an adjusting screw seat 203 to enable precise calibration of the pressure threshold at which the alarm activates, allowing the system to be tuned to trigger at a specific low-pressure point. A spring piston cup 204 houses the piston assembly and provides structural support for the spring mechanism. The actuator further includes a whistle piston 205 that reciprocates within the body 200 in response to pressure changes, moving to open an airflow path when system pressure drops below the set threshold. A whistle orifice 206 provides a precisely sized opening through which air passes when the piston 205 is actuated, creating the pressure signal that is transmitted through hose 195 to activate the remote flute assembly of low pressure alarm 131. An O-ring seal 207 provides sealing for the piston mechanism to prevent air leakage around the piston. A compression spring 208 biases the piston 205 to its normal operating position, holding it closed until system pressure drops sufficiently to overcome the spring force. A series of Belleville washers 209 (e.g., six in total) provide additional spring force and allow fine-tuning of the pressure response characteristics of the actuator. A whistle activator seal 210 ensures pressure-tight operation of the actuator and prevents leakage at critical interfaces. A banjo fitting 211 for the whistle activator provides the connection interface for hose 195 to the manifold 133. Multiple O-ring seals 212 (e.g., two in total) maintain pressure integrity throughout the actuator assembly. A hose barb 213 having an SAE-03 configuration connects to the whistle hose 195 extending to the remote flute assembly to banjo fitting 211, thereby completing the pneumatic connection between the pressure-sensing actuator at the manifold and the audible warning flute near the user's head.

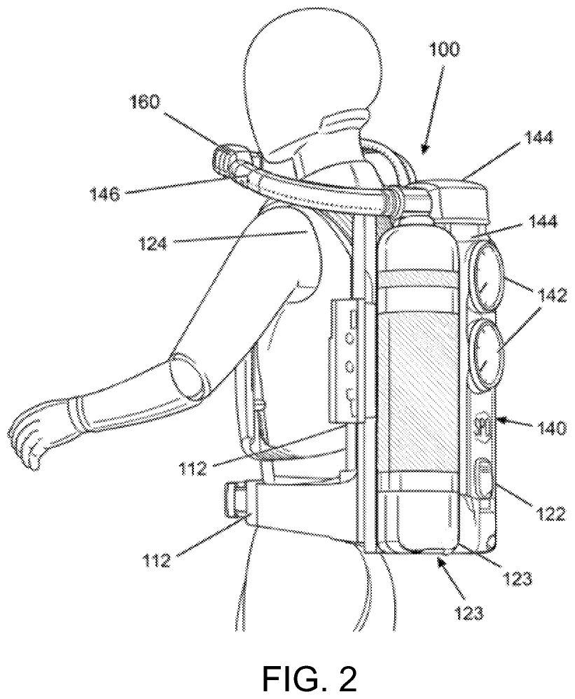

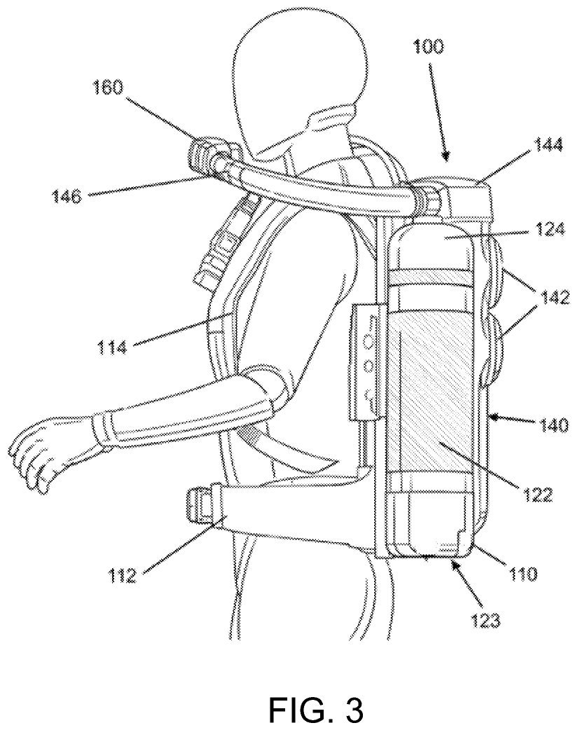

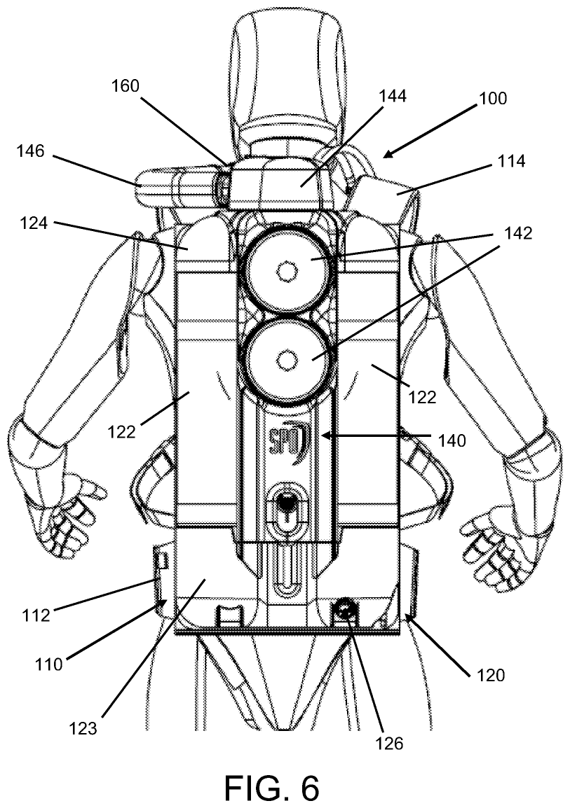

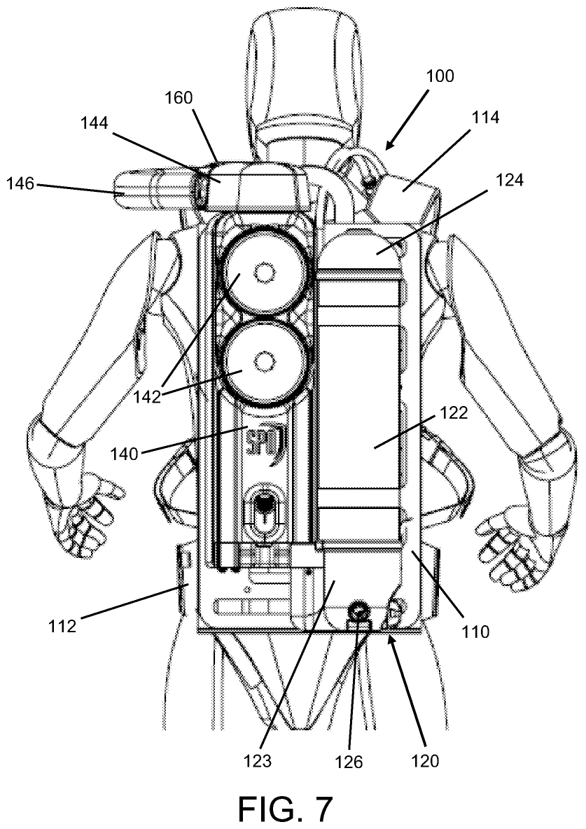

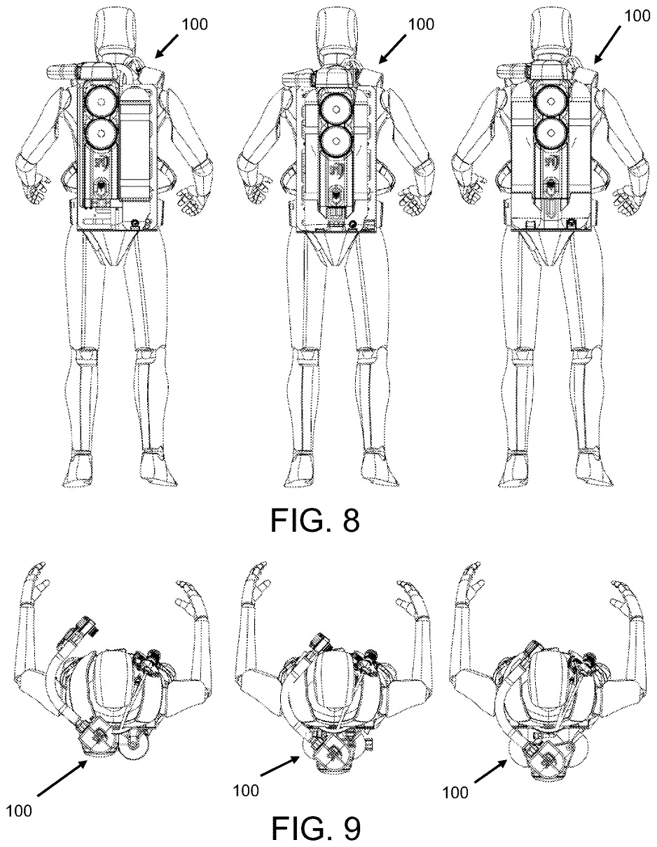

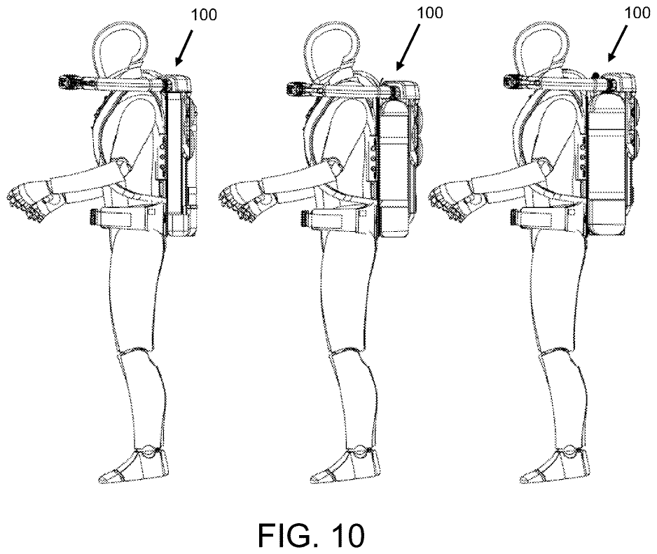

While FIGS. 1-5 show a configuration of modular SCBA/PAPR system 100 in which two high pressure canisters 122 are provided, each having a first volume of compressed air, FIG. 6 shows a configuration of modular SCBA/PAPR system 100 with a second, alternative configuration for the SCBA system in which two high pressure canisters 122 are provided, here each having a second volume of compressed air that is of greater capacity than the first volume of compressed air, as may be appropriate in situations where a longer SCBA air supply may be needed or desired. Likewise, FIG. 7 shows a configuration of modular SCBA/PAPR system 100 with a third, alternative configuration for the SCBA system in which a single high pressure canister 122 is provided, as may be appropriate in situations where a shorter SCBA air supply may be sufficient and weight or space limitations may be relevant. In each such configuration, air canister carrier 120 is equipped with the latching mechanism to removably receive the same PAPR system 140 and is configured for removable attachment to carrier frame 110, thus enabling easy switching of one configuration of canisters 122 for another to meet particular needs for a given environment. FIGS. 8-10 show back, top, and side side-by-side comparisons, respectively, of modular SCBA/PAPR system 100 having differing air canister carrier 120 configurations as discussed above, illustrating the modular flexibility of the system while maintaining a common PAPR system 140 and carrier frame 110 across all configurations.

Next, FIGS. 11-13 show the process for removing the PAPR system 140 from air canister carrier 120. In FIG. 11, the SCBA air hose 148 that is integrated with air delivery hose 146 is disconnected from SCBA air outlet 128. Next, handle 149 is pulled to disengage the latches on the inside of the manifold of PAPR system 140 (retracting the latch members into the air canister carrier 120 to release them from the hooks on the underside of PAPR system 140), and as shown in FIG. 13 with such latches disengaged, PAPR system 140 may be lifted and removed from air canister carrier 120. Each configuration of air canister carrier 120 is preferably configured in like manner to allow easy placement and removal of PAPR system 140, thereby facilitating rapid reconfiguration of the system between different canister configurations without requiring specialized tools or lengthy disassembly procedures.

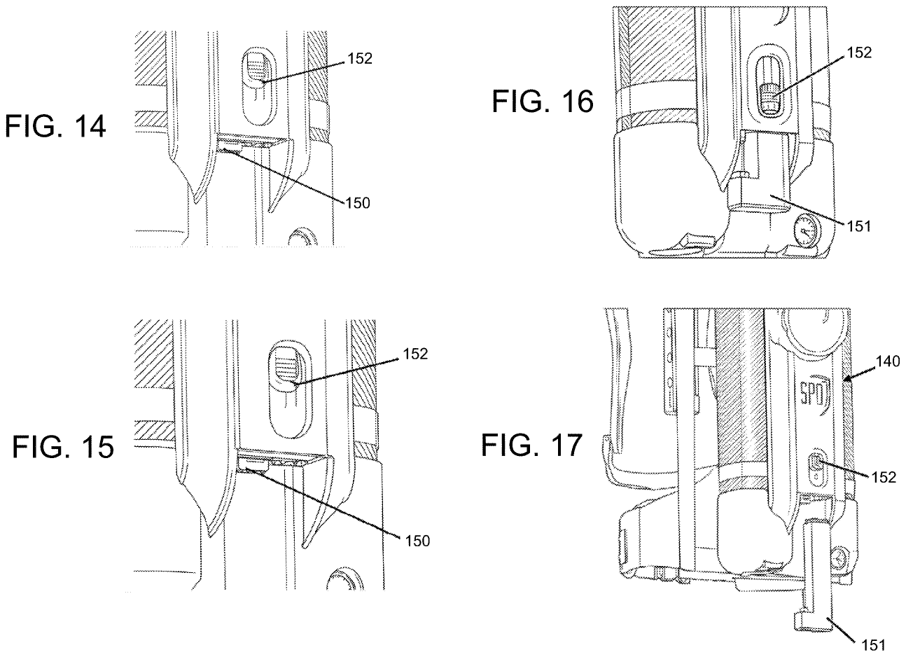

Next, FIGS. 14-17 show the process for changing a battery 151 for powering PAPR system 140, and more particularly for powering blower 144 to draw air through filter cartridges 142 and onward to a user's protective equipment. The PAPR system 140 may include conventional controls (not shown) for activating and deactivating blower 144, allowing the user to control PAPR operation. To change battery 151, first a bottom release button 150 may be pressed inward toward air canister carrier 120 to release the bottom of battery 151 as shown in FIGS. 14-15, and slider 152 may be pressed downward to internally release battery 151 from its connection inside of the manifold of PAPR system 140, allowing its full removal and replacement with a charged battery 151. This battery replacement mechanism enables field replacement of depleted batteries without requiring removal of the PAPR system 140 from the air canister carrier 120, thereby minimizing system downtime during extended operations.

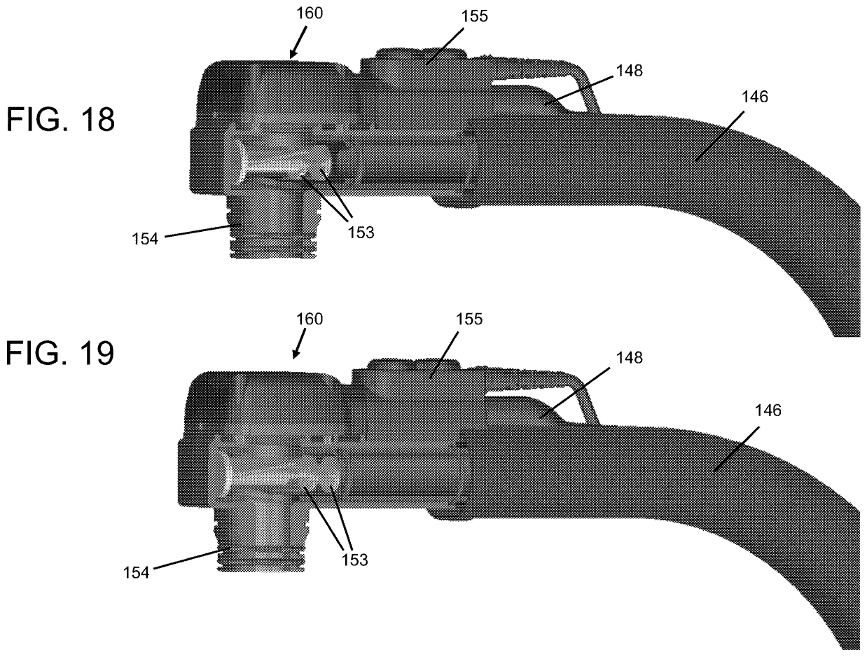

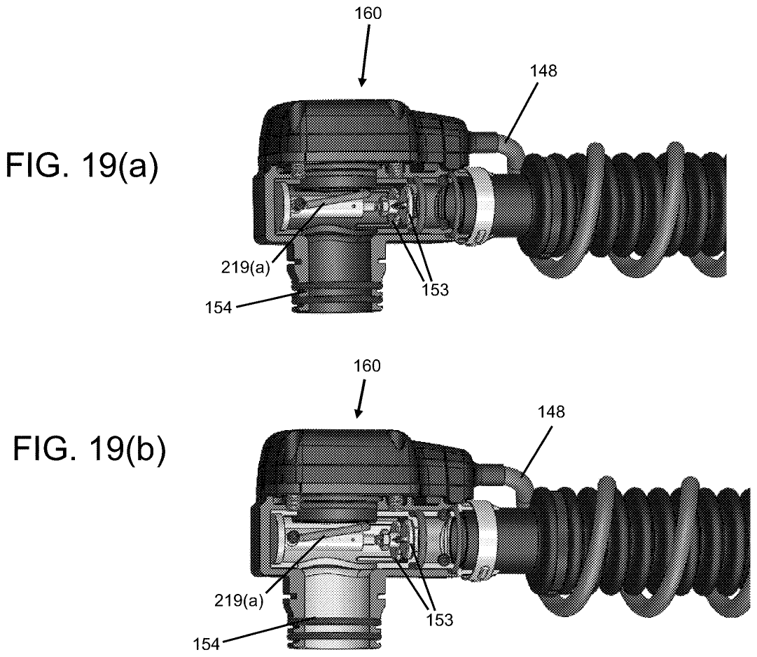

Next, FIGS. 18 and 19 show side cross-sectional views of the second stage regulator 160 configured for swivel attachment to a user's protective equipment, such as a protective mask. In the operational configuration shown in FIG. 18, air may flow through air delivery hose 146 past sealing valve 153 when sealing valve is in an open position. This provides filtered air from PAPR system 140 through outlet 154 and to the user's breathing environment. As shown in FIG. 19, at a user's selection (via switch 155), sealing valve 153 may close such that PAPR system 140 is closed off from outlet 154, and air from SCBA air hose 148 is allowed to flow through outlet 154 and to the user's breathing environment. FIGS. 19(a) and 19(b) show an alternative configuration of second stage regulator 160 in a slightly more compact configuration that provides the same selective airflow control functionality while occupying less space, which may be advantageous in certain applications where a lower profile or reduced weight is desirable.

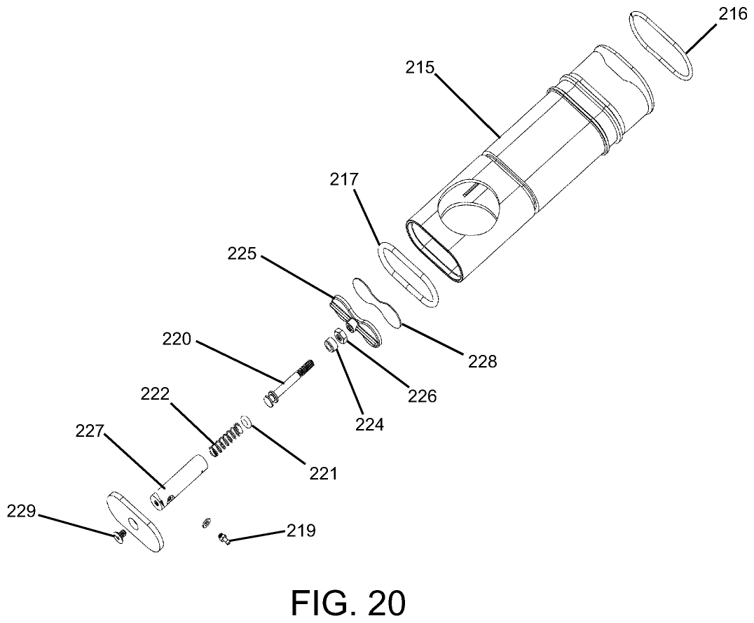

FIG. 20 provides a detailed exploded view of the shutoff sleeve portion of the second stage regulator assembly shown in FIGS. 18-19(b), illustrating the construction and arrangement of components that enable the selective switching between SCBA and PAPR air sources. As shown in FIG. 20, the shutoff sleeve assembly includes a shutoff sleeve 215 that forms the outer housing of the mechanism. The sleeve receives a pair of O-ring seals 216, 217 that provide pressure-tight sealing at key interfaces. The assembly further includes a shutoff cylinder 218 positioned within the sleeve that houses the actuation mechanism. A threaded brass fitting 219 engages shutoff cylinder 218 and provides a connection point for an actuator arm 219(a) (FIGS. 19(a) and 19(b)) to open and close the shutoff assembly. A shutoff piston 220 reciprocates within the cylinder in response to actuation of the switch 155 to selectively open and close the airflow passages. An O-ring seal 221 on the piston ensures pressure-tight operation. A compression spring 222 biases the piston to its operational positions. An end cap 224 for the shutoff cylinder secures the shutoff piston to a shutoff plug 225 with nut 226. An end cap 227 for the shutoff sleeve closes the outer housing. A gasket 228 for the shutoff plug provides sealing at the plug interface. A flat head socket cap screw 229 secures the plug assembly. This shutoff sleeve assembly provides reliable, repeatable switching between air sources while maintaining pressure integrity and minimizing air leakage during transitions.

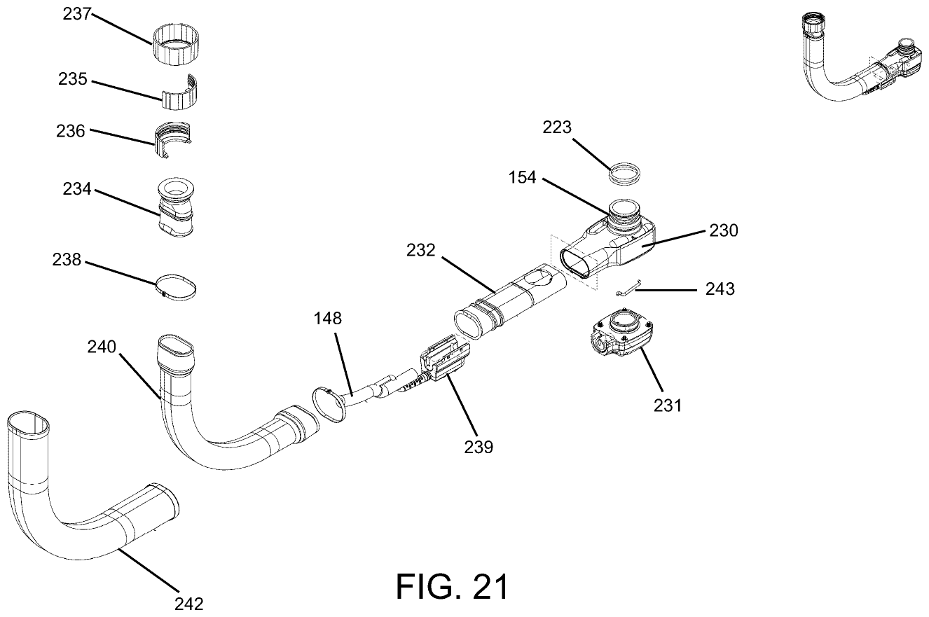

Next, FIG. 21 provides a detailed exploded view of the combination hose assembly that extends from the PAPR portion blower 144 to the demand valve and mask swivel housing of the modular SCBA/PAPR system. As illustrated in FIG. 21, the combination hose assembly includes a mask swivel housing 230 that provides the connection interface to the user's protective mask. A demand valve assembly 231 configured as described above regulates airflow in response to the user's breathing. The shutoff sleeve assembly 232 (shown in detail in FIG. 20) is incorporated into the hose assembly. The assembly further includes multiple O-ring seals 233 about the outlet 154 to maintain pressure integrity at the interface with the user's protective equipment. A straight connector 234 forms the connection between the blower 144 and the combination hose assembly, and is joined to the hose assembly with right and left nuts 235, 236 and hose end nut retainer 237 that secure the straight connector 234 to blower 144. Cable ties 238 may also be used to further seal the connection between straight connector 234 and the combination hose assembly. SRS (Second stage Regulator System) assembly 239 integrates the regulator components specific to the modular SCBA configuration. A butyl hose 240 provides the airflow conduit from blower 144 to shutoff sleeve assembly 232 with chemical resistance and flexibility. The second stage hose 148 delivers SCBA air from the air canister sources to the regulator. A fabric sleeve 242 surrounds and protects the breathing hose from abrasion and environmental damage. A shutoff tubing 243 connects the shutoff mechanism to the control switch 155, allowing the user to remotely actuate the air source selection. This integrated combination hose assembly provides a unified, streamlined connection between the air supply systems and the user's breathing interface while incorporating the selective switching capability that enables seamless transition between SCBA and PAPR modes of operation.

The modular SCBA/PAPR system 100 as described herein provides significant operational advantages over traditional separate SCBA and PAPR systems. The ability to quickly reconfigure the SCBA portion by swapping air canister carriers 120 with different canister configurations while retaining the same PAPR system 140, carrier frame 110, and second stage regulator 160 allows users to optimize their equipment for specific mission parameters without requiring duplicate complete systems. The integrated second stage regulator 160 with its shutoff sleeve assembly enables instant switching between filtered ambient air (PAPR mode) and contained pressurized air (SCBA mode) through simple actuation of switch 155, providing operational flexibility to respond to changing environmental conditions. The recharge capability provided through recharge connector 127 extends operational duration by allowing in-field refilling of canisters 122 without system disassembly. The integrated pressure monitoring through pressure gauges 126 and 129, combined with the low pressure audible alarm 131, ensures the user maintains awareness of air supply status. The quick-release battery replacement mechanism shown in FIGS. 14-17 minimizes PAPR system downtime during extended operations. The swivel connection of second stage regulator 160 to the protective mask provides freedom of movement without hose binding or disconnecting. Together, these features provide a comprehensive, integrated breathing apparatus system that offers the benefits of both SCBA and PAPR technologies in a single modular platform that can be rapidly reconfigured to meet diverse operational requirements.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

What is claimed is:

1. A modular breathing apparatus system comprising:
a body-worn carrier frame having attachment straps configured to secure the system to a user's back;
a removable air canister carrier removably attached to the carrier frame, the air canister carrier including a bottom canister receiver and a top canister receiver configured to receive at least one pressurized air canister having a manifold;
a powered air purifying respirator (PAPR) system removably attached to the air canister carrier, the PAPR system including at least one filter cartridge, a blower configured to draw air through the at least one filter cartridge, and an air delivery hose for delivering filtered air from the blower;
an SCBA air outlet configured for fluid communication with the manifold for delivering pressurized air from the at least one pressurized air canister;
an SCBA air hose in fluid communication with the SCBA air outlet; and
a second stage regulator configured for attachment to protective equipment worn by a user, the second stage regulator having an outlet for delivering air to the user, wherein the second stage regulator is configured to selectively receive air from either the PAPR system via the air delivery hose or from the at least one pressurized air canister via the SCBA air hose.

2. The modular breathing apparatus system of claim 1, wherein the air canister carrier is configured to accommodate different configurations of pressurized air canisters varying in at least one of size and number while maintaining compatibility with the PAPR system.

3. The modular breathing apparatus system of claim 1, wherein the PAPR system includes a latching mechanism configured to removably secure the PAPR system to the air canister carrier, the latching mechanism being manually operable to disengage and allow removal of the PAPR system from the air canister carrier.

4. The modular breathing apparatus system of claim 3, wherein the latching mechanism includes a manually operable handle configured to disengage latches to permit lifting and removal of the PAPR system from the air canister carrier.

5. The modular breathing apparatus system of claim 1, wherein the second stage regulator includes a sealing valve and a switch, the sealing valve being movable between an open position permitting airflow from the PAPR system to the outlet and a closed position blocking airflow from the PAPR system while permitting airflow from the SCBA air hose to the outlet, the switch being operable to control the position of the sealing valve.

6. The modular breathing apparatus system of claim 1, further comprising a recharge connector in fluid communication with the manifold, the recharge connector including at least one refill port configured to receive pressurized air from an external source for refilling the at least one pressurized air canister.

7. The modular breathing apparatus system of claim 6, wherein the recharge connector includes a pressure gauge providing a visual indication of air pressure supplied by the system.

8. The modular breathing apparatus system of claim 1, further comprising a low pressure audible alarm in fluid communication with the manifold, the low pressure audible alarm being configured to emit an audible warning tone when pressure in the system falls below a predetermined threshold.

9. The modular breathing apparatus system of claim 8, wherein the low pressure audible alarm includes a whistling valve having a manually operable closure configured to stop emission of the warning tone.

10. The modular breathing apparatus system of claim 8, wherein the low pressure audible alarm includes a check valve configured to prevent backflow of ambient air into the system.

11. The modular breathing apparatus system of claim 1, wherein the PAPR system includes a battery and a battery replacement mechanism configured to permit removal and replacement of the battery without requiring removal of the PAPR system from the air canister carrier.

12. The modular breathing apparatus system of claim 11, wherein the battery replacement mechanism includes a bottom release button and a slider, the bottom release button being operable to release a bottom portion of the battery and the slider being operable to internally release the battery from connection within the PAPR system.

13. The modular breathing apparatus system of claim 1, wherein the second stage regulator is configured for swivel attachment to a protective mask.

14. A modular self-contained breathing apparatus (SCBA) and powered air purifying respirator (PAPR) system comprising:
a body-worn carrier frame;
a first air canister carrier removably attached to the carrier frame and configured to receive a first configuration of at least one pressurized air canister;
a second air canister carrier removably attachable to the carrier frame in place of the first air canister carrier, the second air canister carrier being configured to receive a second configuration of at least one pressurized air canister, wherein the second configuration differs from the first configuration in at least one of canister size and number of canisters;
a PAPR system removably attachable to each of the first air canister carrier and the second air canister carrier, the PAPR system including at least one filter cartridge, a blower, and an air delivery hose; and
a second stage regulator in fluid communication with both the PAPR system and an SCBA air outlet from the air canister carrier, the second stage regulator being configured to selectively deliver air to a user from either the PAPR system or from the at least one pressurized air canister.

15. The system of claim 14, wherein each of the first air canister carrier and the second air canister carrier includes a latching mechanism configured to removably receive and secure the PAPR system.

16. The system of claim 14, wherein the second stage regulator includes a shutoff sleeve assembly comprising a shutoff sleeve, a shutoff cylinder, a shutoff piston, and a compression spring, the shutoff piston being movable to selectively open and close airflow passages between the PAPR system and an outlet of the second stage regulator.

17. The system of claim 14, further comprising a combination hose assembly integrating the air delivery hose from the PAPR system and an SCBA air hose, the combination hose assembly extending from the blower to the second stage regulator and including a fabric sleeve surrounding and protecting the hoses.

18. A method of reconfiguring a modular breathing apparatus system, the method comprising:
providing a modular breathing apparatus system including a carrier frame, a first air canister carrier attached to the carrier frame and carrying at least one pressurized air canister, and a PAPR system attached to the first air canister carrier;
disconnecting an SCBA air hose from an SCBA air outlet;
disengaging a latching mechanism to release the PAPR system from the first air canister carrier;
removing the PAPR system from the first air canister carrier;
removing the first air canister carrier from the carrier frame;
attaching a second air canister carrier to the carrier frame, the second air canister carrier being configured to carry a different configuration of at least one pressurized air canister than the first air canister carrier;
engaging the latching mechanism to attach the PAPR system to the second air canister carrier; and
connecting the SCBA air hose to an SCBA air outlet of the second air canister carrier.

19. The method of claim 18, wherein the different configuration comprises at least one of a different number of pressurized air canisters and a different size of pressurized air canister.

20. The method of claim 18, wherein disengaging the latching mechanism comprises pulling a handle to disengage latches positioned on an interior side of the PAPR system.
